(19) United States
(12) Patent Application Publication
(10) Pub. No.: US 2026/0223084 A1
(43) Pub. Date: Jul. 30, 2026

(54) SIDELINK RESOURCE SELECTION BASED ON RESOURCE BLOCK SET INFORMATION FOR MULTI-CONSECUTIVE SLOT RESOURCES

(71) Applicant: QUALCOMM Incorporated, San Diego, CA (US)

(72) Inventors: Giovanni CHISCI, San Diego, CA (US); Qing LI, Princeton Junction, NJ (US); Chih-Hao LIU, San Diego, CA (US); Stelios STEFANATOS, San Diego, CA (US); Jing SUN, San Diego, CA (US); Xiaoxia ZHANG, San Diego, CA (US); Shaozhen GUO, Beijing (CN)

(21) Appl. No.: 19/143,235

(22) PCT Filed: Feb. 10, 2023
(86) PCT No.: PCT/CN2023/075407

§ 371 Date: Jun. 25, 2025

(51) Int. Cl. H04W 72/0446; H04W 72/40

(52) U.S. Cl. CPC H04W 72/0446; H04W 72/40

(57) ABSTRACT

Various aspects of the present disclosure generally relate to wireless communication. In some aspects, a user equipment (UE) may select, based at least in part on resource block (RB) set information, at least one multi consecutive slot resource (MCSr) from a configured resource pool. The UE may transmit, based at least in part on a channel access procedure, a plurality of sidelink communications via the at least one MCSr. Numerous other aspects are described.

### FIELD OF THE DISCLOSURE

Aspects of the present disclosure generally relate to wireless communication and to techniques and apparatuses for sidelink resource selection based on resource block set information for multi-consecutive slot resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication over an unlicensed spectrum carrier. The user equipment may include a memory and one or more processors coupled to the memory. The one or more processors may be configured to select, based at least in part on resource block (RB) set information, at least one multi consecutive slot resource (MCSr) from a configured resource pool. The one or more processors may be configured to transmit, based at least in part on a channel access procedure, a plurality of sidelink communications via the at least one MCSr.

Some aspects described herein relate to a method of wireless communication performed by a UE over an unlicensed spectrum carrier. The method may include selecting, based at least in part on RB set information, at least one MCSr from a configured resource pool. The method may include transmitting, based at least in part on a channel access procedure, a plurality of sidelink communications via the at least one MCSr.

Some aspects described herein relate to a non-transitory computer-readable medium that stores a set of instructions for wireless communication by a UE. The set of instructions, when executed by one or more processors of the UE, may cause the UE to select, based at least in part on RB set information, at least one MCSr from a configured resource pool. The set of instructions, when executed by one or more processors of the UE, may cause the UE to transmit, based at least in part on a channel access procedure, a plurality of sidelink communications via the at least one MCSr.

Some aspects described herein relate to an apparatus for wireless communication. The apparatus may include means for selecting, based at least in part on RB set information, at least one MCSr from a configured resource pool. The apparatus may include means for transmitting, based at least in part on a channel access procedure, a plurality of sidelink communications via the at least one MCSr.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIGS. 5A-5C are diagrams illustrating examples associated with resource selection for sidelink communications, in accordance with the present disclosure.

FIGS. 6A-6C are diagrams illustrating examples associated with sidelink resource selection based on resource block (RB) set information for multi consecutive slot transmissions (MCSts), in accordance with the present disclosure.

FIG. 7 is a diagram illustrating an example process performed, for example, by a UE, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Selection of sidelink resources, via a medium access control (MAC) layer and a physical (PHY) layer for a Mode 2 user equipment (UE) can occur over a resource pool. In the configured sidelink bandwidth part (BWP) in the unlicensed channel, each resource pool can be divided into a set of resource block (RB) sets. Each RB set can be divided into a set of subchannels and each subchannel can be divided into a set of RBs. To use subchannels within an RB set, a related listen-before-talk (LBT) procedure can be successfully performed. The more RB sets that are spanned in the resource selection (e.g., the more RB sets that are at least partially overlapping with the selected LsubCH contiguous subchannels), the less likely it is that all required LBTs are to be successful.

To support multi-consecutive-slot-transmission (MCSt) in the unlicensed band, multi-slot resources (sets of contiguous single-slot resources) may need to be available. The more RB sets are spanned in the resource selection, the more likely multi-slot candidate resources can be found. The number of candidate multi-slot resources can be increased by increasing the reference signal received power (RSRP) threshold of resource exclusion, thereby, accepting more collisions with transmissions of reserving UEs. However, increasing the number of RB sets considered in resource selection to increase the likelihood of finding multi-slot resources of a desired length may result in a decreased likelihood of channel access success, thereby negatively impacting sidelink device performance.

Some aspects of the techniques and apparatuses described herein may include using RB set information to facilitate selection of multi consecutive slot resources (MCSrs) from a configured resource pool. The RB set information may include information associated with RB sets and may facilitate selection of MCSrs from RB sets. RB set information may include information associated with LBT failures, overlapping reservations, and/or priorities, among other examples. In some aspects, a MAC layer of the UE may not provide RB set information to the PHY layer, and the PHY layer may identify multi-slot candidate resources within the entire resource pool. In some aspects, the MAC layer may provide pre-selected RB set information as supplementary information to the PHY layer. In some aspects, the PHY layer may provide an ordered listing of MCSr candidates to the MAC layer for resource selection. By considering RB set information when selecting MCSrs (in either an initial resource selection procedure or a re-selection procedure), some aspects may facilitate increasing a likelihood of selecting multi-slot resources of a desired length while mitigating a potential impact on channel access likelihood, thereby positively impacting sidelink device performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

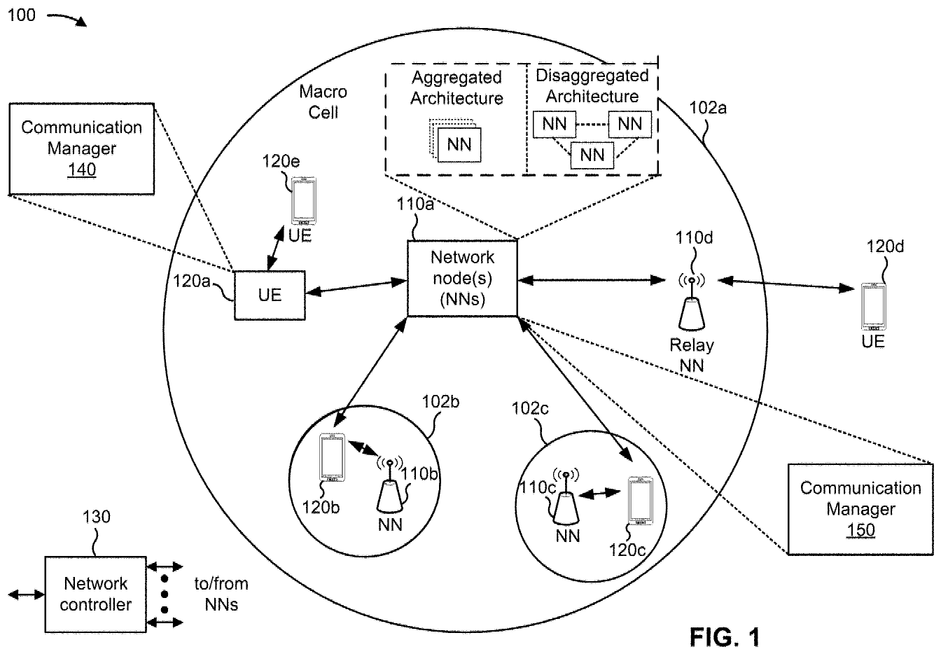

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may select, based at least in part on resource block (RB) set information, at least one multi consecutive slot resource (MCSr) from a configured resource pool; and transmit, based at least in part on a channel access procedure, a plurality of sidelink communications via the at least one MCSr. Additionally, or alternatively, the communication manager 140 may perform one or more other operations described herein.

As indicated above, FIG. 1 is provided as an example. Other examples may differ from what is described with regard to FIG. 1.

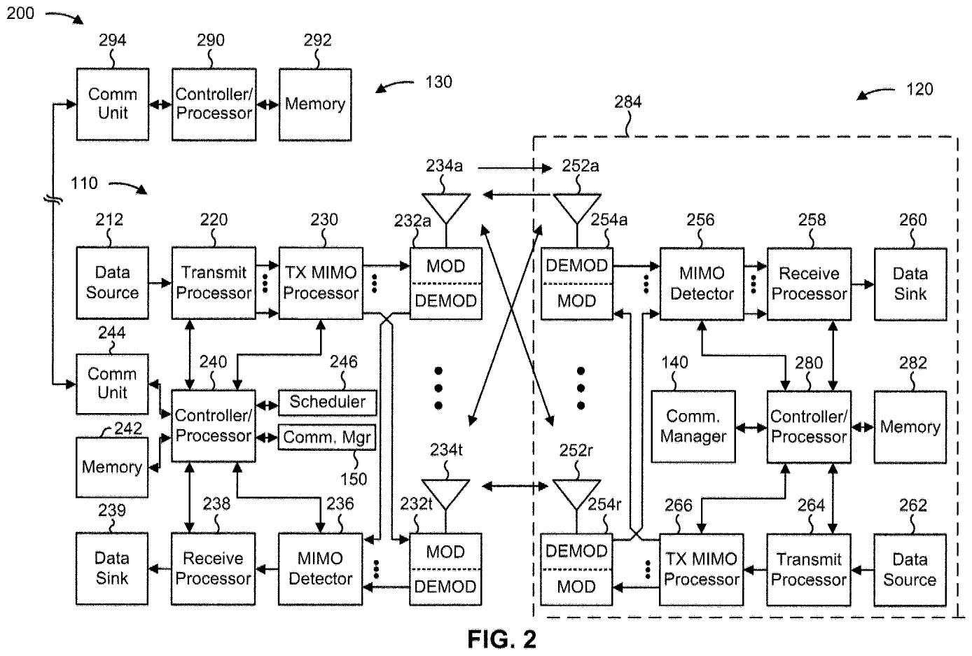

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

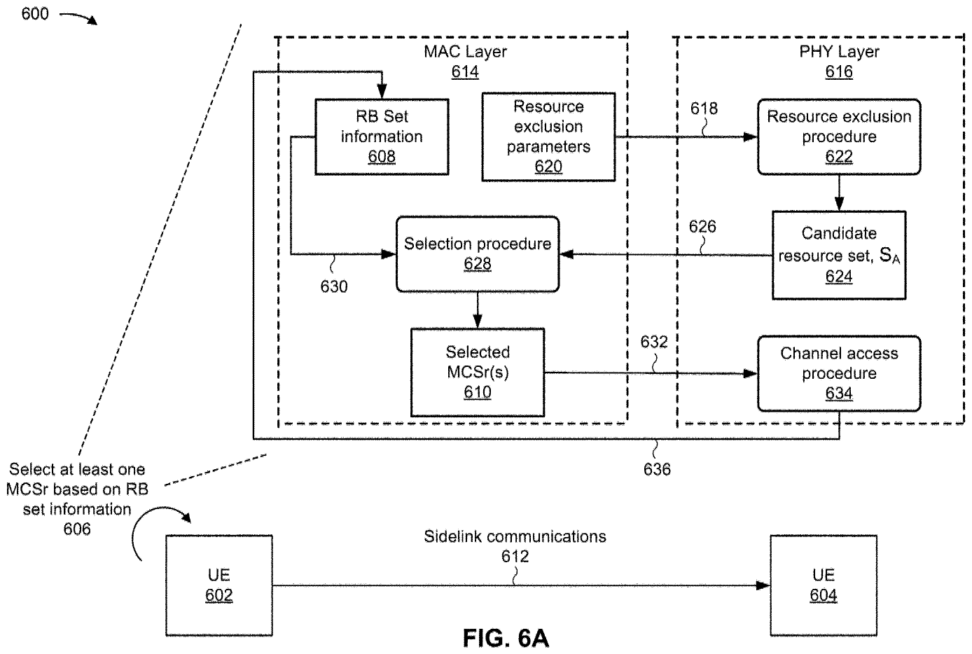

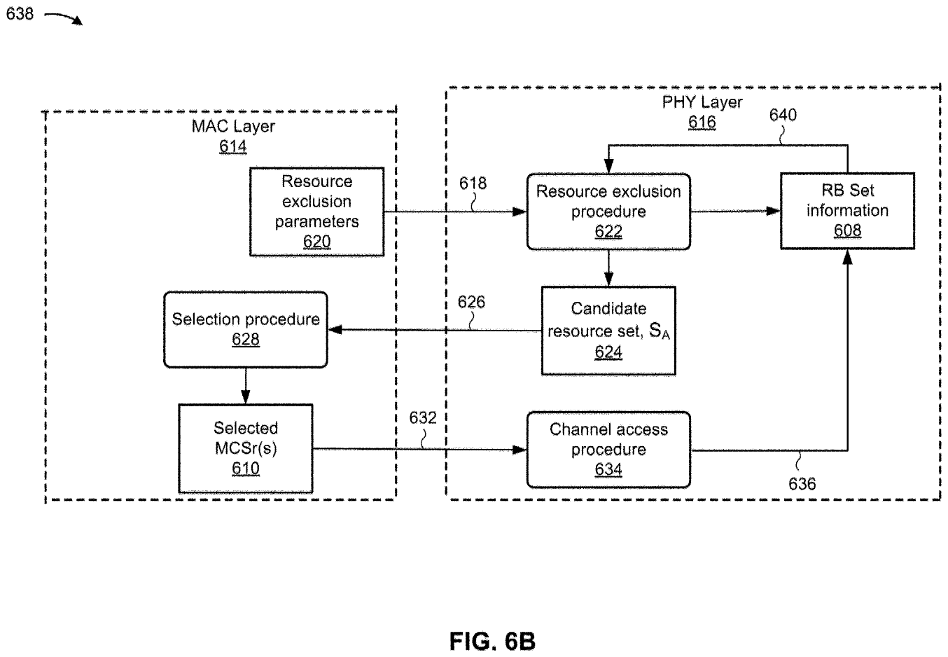

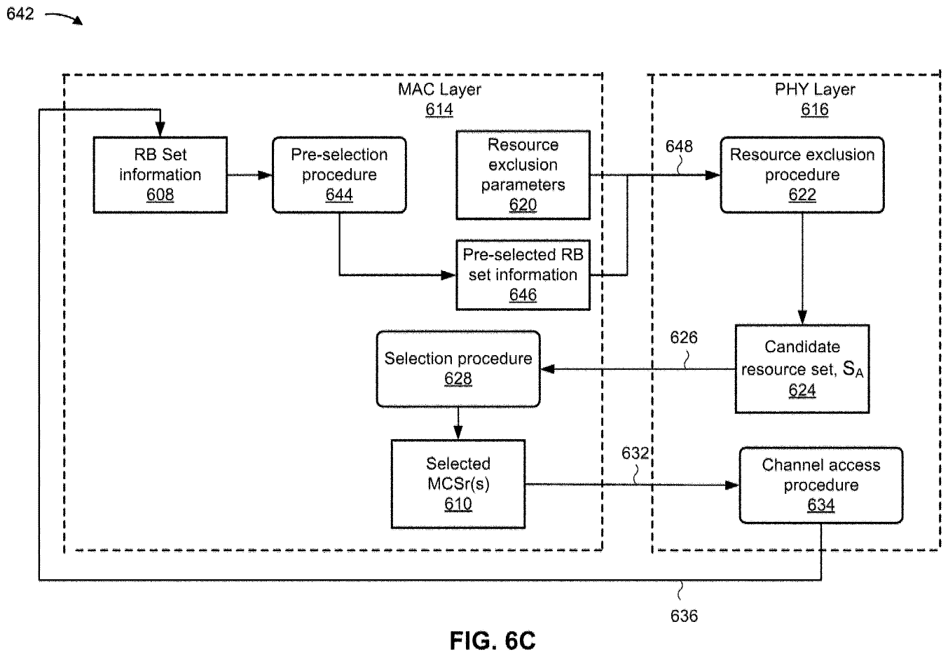

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-9).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

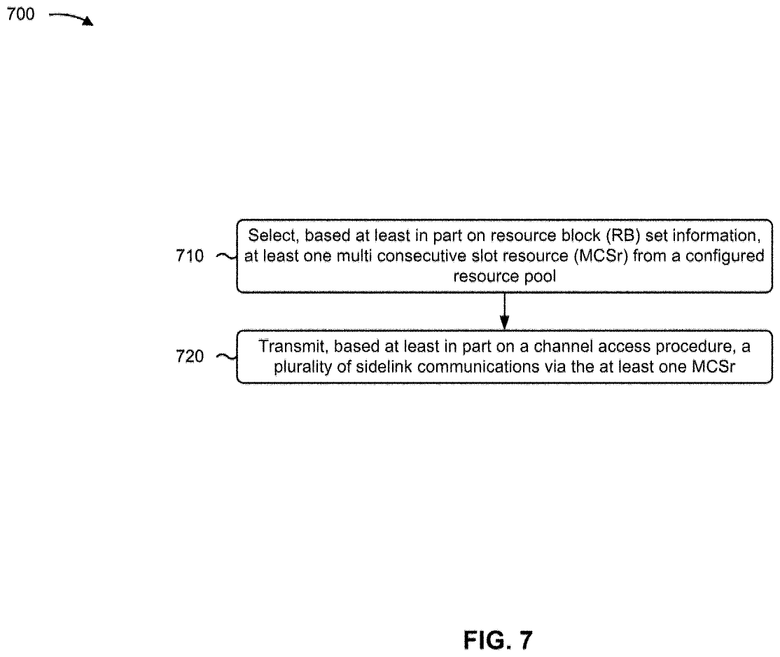

The controller/processor 240 of the network node 110, the controller/processor 280 of the UE 120, and/or any other component(s) of FIG. 2 may perform one or more techniques associated with sidelink resource selection based on RB set information for MCSrs, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7 and/or other processes as described herein. In some examples, executing instructions may include running the instructions, converting the instructions, compiling the instructions, and/or interpreting the instructions, among other examples.

In some aspects, a UE (e.g., the UE 120) includes means for selecting, based at least in part on RB set information, at least one MCSr from a configured resource pool; and/or means for transmitting, based at least in part on a channel access procedure, a plurality of sidelink communications via the at least one MCSr. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

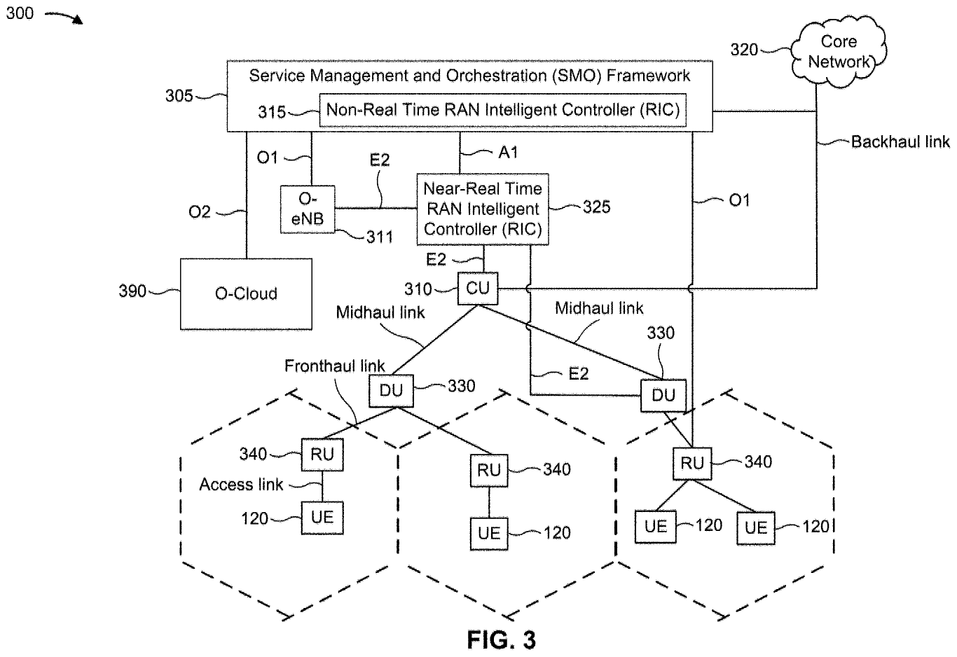

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high PHY layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

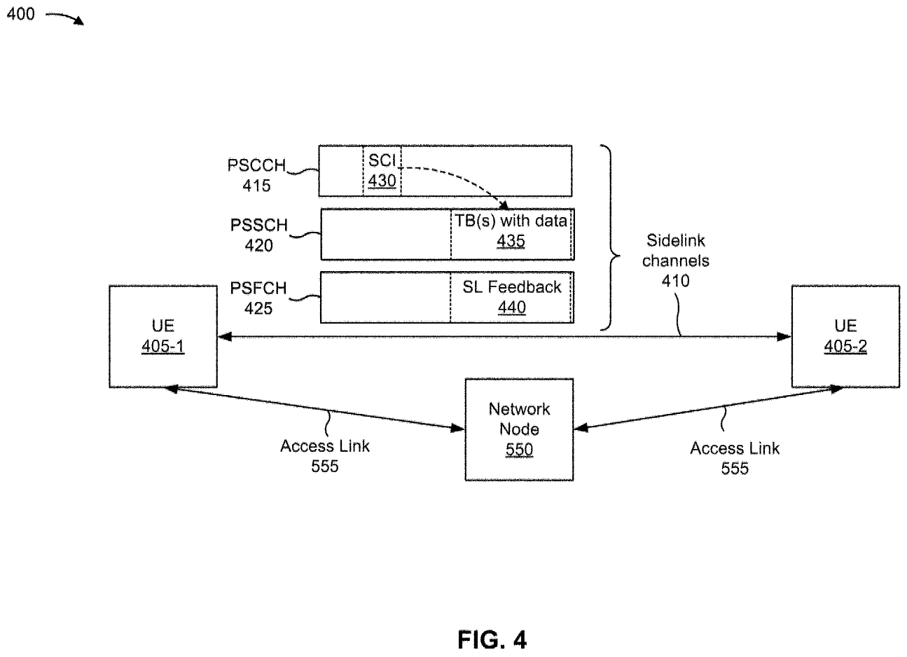

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a PSSCH 420, and/or a PSFCH 425. The PSCCH 415 may be used to communicate control information, similar to a physical downlink control channel (PDCCH) and/or a PUCCH used for cellular communications with a BS 110 via an access link or an access channel. The PSSCH 420 may be used to communicate data, similar to a PDSCH and/or a physical uplink shared channel (PUSCH) used for cellular communications with a BS 110 via an access link or an access channel. For example, the PSCCH 415 may carry SCI 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as HARQ feedback (e.g., ACK/NACK information), transmit power control (TPC), and/or a scheduling request (SR).

HARQ feedback provides a mechanism for indicating, to a transmitter of a communication, whether the communication was successfully received or not. For example, the transmitter may transmit scheduling information for the communication. A receiver of the scheduling information may monitor resources indicated by the scheduling information in order to receive the communication. If the receiver successfully receives the communication, the receiver may transmit an acknowledgment (ACK) in HARQ feedback. If the receiver fails to receive the communication, the receiver may transmit a negative ACK (NACK) in HARQ feedback. Thus, based at least in part on the HARQ feedback, the transmitter can determine whether the communication should be retransmitted. HARQ feedback is often implemented using a single bit, where a first value of the bit indicates an ACK and a second value of the bit indicates a NACK. Such a bit may be referred to as a HARQ-ACK bit. HARQ-ACK feedback may be conveyed in a HARQ codebook, which may include one or more bits indicating ACKs or NACKs corresponding to one or more communications and may be referred to as HARQ feedback information (or, in the case of sidelink communications, “sidelink HARQ feedback information”).

A HARQ-ACK bit may be referred to as an ACK/NACK and/or a HARQ-ACK and may be associated with a HARQ process. The HARQ process refers to the determination of whether to report an ACK or NACK associated with a transmission, a time resource associated with the transmission (e.g., a symbol or a slot), and/or a frequency resource associated with the transmission (e.g., a resource block (RB), a subchannel, a channel, a bandwidth, and/or a bandwidth part). Accordingly, an ACK/NACK may be interchangeably referred to as being associated with a transmission, a time resource, a frequency resource, and/or a HARQ process.

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. Resource pools may be defined for sidelink transmission and sidelink reception. A resource pool may include one or more sub-channels in the frequency domain and one or more slots in the time domain. For example, the minimum resource allocation in the frequency domain may be a sub-channel, and the minimum resource allocation in the time domain may be a slot. In some aspects, one or more slots of a resource pool may be unavailable for sidelink communications. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405-1 may operate using a sidelink transmission mode (e.g., Mode 1) where resource selection and/or scheduling is performed by a BS 110 (e.g., a base station, a CU, or a DU). For example, the UE 405-1 may receive a grant (e.g., in DCI or in an RRC message, such as for configured grants) from the BS 110 (e.g., directly or via one or more network nodes) for sidelink channel access and/or scheduling. In some aspects, a UE 405-1 may operate using a transmission mode (e.g., Mode 2) where resource selection and/or scheduling is performed by the UE 405-1 (e.g., rather than a BS 110). In some aspects, the UE 405-1 may perform resource selection and/or scheduling by sensing channel availability for transmissions. For example, the UE 405-1 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405-1 may perform resource selection and/or scheduling using SCI 430 received in the PSCCH 415, which may indicate occupied resources and/or channel parameters. Additionally, or alternatively, the UE 405-1 may perform resource selection and/or scheduling by determining a channel busy ratio (CBR) associated with various sidelink channels, which may be used for rate control (e.g., by indicating a maximum number of resource blocks that the UE 405-1 can use for a particular set of subframes).

In the transmission mode where resource selection and/or scheduling is performed by a UE 405-1, the UE 405-1 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405-1 may generate a sidelink grant that indicates one or more parameters for semi-persistent scheduling (SPS), such as a periodicity of a sidelink transmission. Additionally, or alternatively, the UE 405-1 may generate a sidelink grant for event-driven scheduling, such as for an on-demand sidelink message.

As shown, a network node 450 may communicate with the UE 405-1 and/or the UE 405-2 (e.g., directly or via one or more network nodes), such as via an access link 455. A direct link between the UEs 405-1 and 405-2 (e.g., via a PC5 interface) may be referred to as a sidelink, and a direct link between a network node 450 and a UE 405-1 or 405-2 (e.g., via a Uu interface) may be referred to as an access link. Sidelink communications may be transmitted via the sidelink, and access link communications may be transmitted via the access link. An access link communication may be either a downlink communication (from the network node 450 to the UE 405-1 or 405-2) or an uplink communication (from a UE 405-1 or 405-2 to the network node 450).

Additionally, or alternatively, the UE 405-1 and/or 405-2 can perform resource selection and/or scheduling using SCI 430 received in the PSCCH 415, which can indicate occupied resources and/or channel parameters. Additionally, or alternatively, the UE 405-1 and/or 405-2 can perform resource selection and/or scheduling by determining a CBR associated with various sidelink channels, which can be used for rate control (e.g., by indicating a maximum number of resource blocks that the UE 405-1 and/or 405-2 can use for a particular set of subframes).

In the second transmission mode, the UE 405-1 and/or 405-2 can generate sidelink grants, and can transmit the grants in SCI 430. A sidelink grant can indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), and/or one or more subframes to be used for the upcoming sidelink transmission. In some aspects, a UE 405-1 and/or 405-2 can generate a sidelink grant that indicates one or more parameters for SPS, such as a periodicity of a sidelink transmission. Additionally, or alternatively, the UE 405-1 and/or 405-2 can generate a sidelink grant for event-driven scheduling, such as for an on-demand sidelink message.

As indicated above, FIG. 4 is provided as an example. Other examples may differ from what is described with respect to FIG. 4.

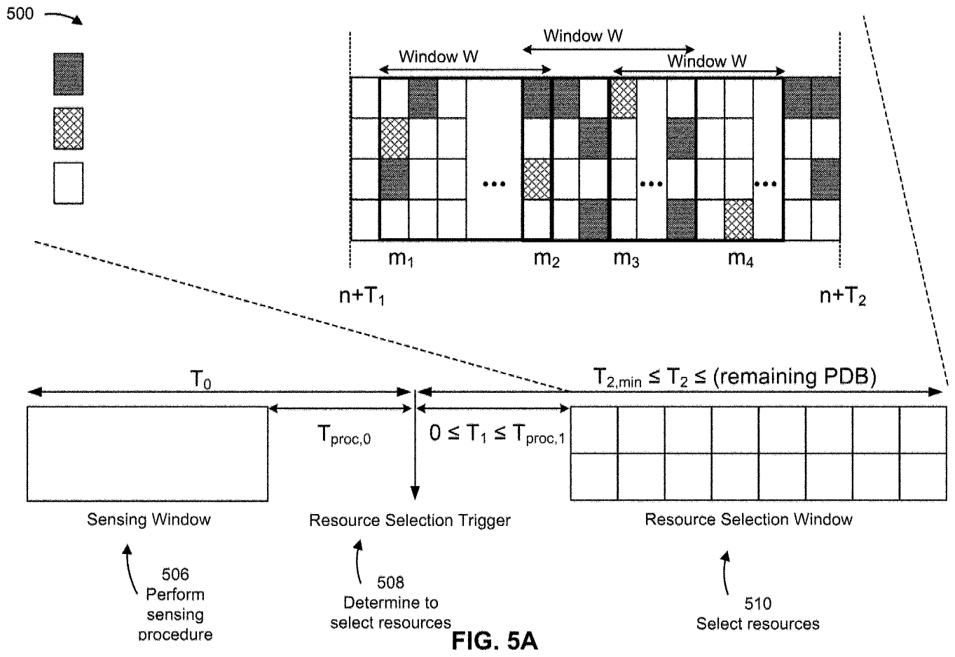

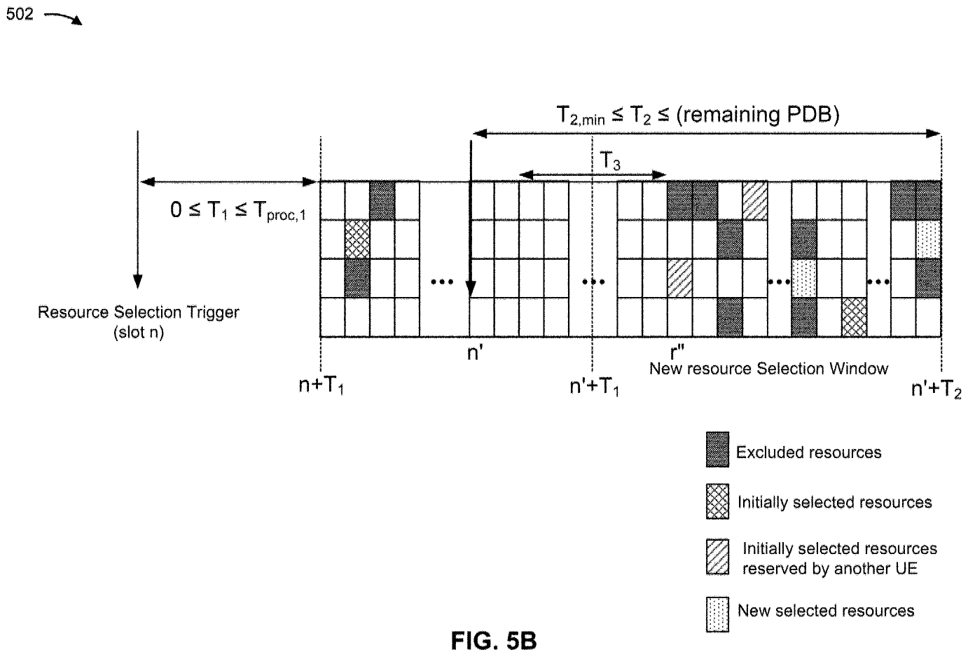

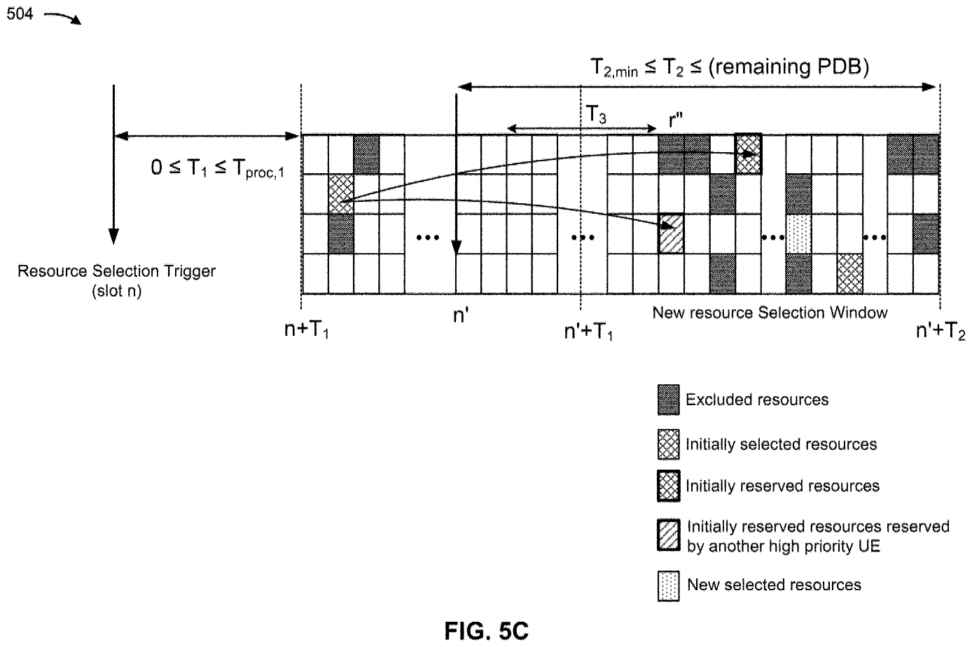

FIGS. 5A-5C are diagrams illustrating examples 500, 502, and 504 associated with resource selection for sidelink communications, in accordance with the present disclosure. The example 500 shows a scheme for resource selection performed by a UE (e.g., the UE 450-1 and/or the UE 450-2 depicted in FIG. 4 and/or the UE 120 depicted in FIGS. 1-3). The scheme for resource selection can include sensing a sidelink channel, based on a resource selection window, for selecting resources for a sidelink communication. A UE can use a channel sensing procedure to select resources for sidelink communication, such as described above in connection with FIG. 4.

In Mode 2, resource selection may include two steps. In a first step, the UE can identify candidate resources using sensing procedures and/or exclusion procedures. In a second step, the UE can perform a resource selection procedure in which the UE selects candidate resources from the identified candidate resources. Selection can be performed by higher protocol stack layers using random selection.

As shown by reference number 506, the UE may perform a sensing procedure in a sensing window. The sensing window is the time interval defined by a range of slots [n-T₀, n-T_{proc,0}], where n is the resource selection (or reselection) trigger or slot at which new resources must be selected, T₀ is configured as 100 milliseconds (ms) (e.g., for aperiodic resource reservation, such as aperiodic reservation in one or more slots of up to 32 logical slots in the future) or 1100 ms (e.g., for periodic resource reservation), and T_{proc,0} is the time required to complete the sensing procedure. In some cases, a UE configured for communication in an NR network can use a sensing procedure for aperiodic or periodic resource reservation.

According to the channel sensing procedure, the UE can decode control messages relating to resource reservations of other UEs, as well as perform measurements (e.g., RSRP measurements and/or RSSI measurements, among other examples) associated with one or more sidelink channels. For example, UEs can transmit reservation information (e.g., in SCI) that indicates a resource reservation for a current slot (e.g., the slot in which the reservation information is transmitted) and for one or more (e.g., up to two) future slots. A resource allocation associated with a resource reservation may be one or more sub-channels in a frequency domain and one slot in a time domain. In some cases, a resource reservation may be aperiodic or periodic. In periodic resource reservation, a UE can signal (e.g., in the reservation information in SCI) a period for the resource reservation (e.g., a value between 0 ms and 1000 ms). In some cases, the sensing procedure can be performed by a physical layer of the UE based on a request from a MAC layer of the UE.

As shown by reference number 508, the UE can determine to select resources for a sidelink communication based at least in part on a resource selection trigger. For example, resource selection can be triggered when the UE has a packet that is to be transmitted or when the UE receives an indication to select (or reselect) resources for a packet that is to be transmitted by the UE. Based at least in part on the resource selection trigger, the UE can determine one or more resources that are available for selection in a resource selection window. That is, the UE can determine the one or more available resources based at least in part on the channel sensing procedure performed by the UE. For example, the channel sensing procedure may provide an indication of resources in the resource selection window that are occupied and/or resources in the resource selection window associated with high interference.

As shown, if the resource selection trigger occurs at a slot n, the resource selection window can be from n+T₁ to n+T₂. In some aspects, T₁ can be less than a processing time (T_{proc,1}) associated with the UE. In some aspects, T₂ can be greater than or equal to T_{2,min}, which can be a value configured for the UE based at least in part on a priority of the UE, and less than or equal to a remaining packet delay budget (PDB) of the packet to be transmitted by the UE. A PDB is a constraint dictating a maximum delay between a time of packet arrival and a time of a last transmission of the packet. For example, each packet that arrives at a transmitter of a UE for transmission by the transmitter is associated with a PDB and a quantity of transmissions (a quantity of times that the packet is to be transmitted). The PDB and the quantity of transmissions can vary among packets depending on, for example, an application or a service associated with the packet (e.g., in order to achieve a desired coverage, range, reliability, and/or the like).

The resource selection window can include all the resources within the range of slot [n+T₁, n+T₂]. The UE can exclude resources in the resource selection window, as shown. In some cases, the UE can exclude resources related to half-duplex operation since a half-duplex UE cannot sense the reservations from other UEs announced in the slot of the sensing window where the UE was transmitting. In some cases, the UE can exclude candidate resources based on the reservations reserved from other UEs in SCI-1 transmissions detected during the sensing window.

The PHY layer of the UE can report the set of candidate resources to the MAC layer of the UE. The MAC layer randomly chooses for transmission one or more resources of the set of candidate resources reported. In some cases, the UE can be reserving resources for a HARQ transmission and/or retransmission, and the resources for multiple PSSCHs for the same transmission block can be randomly selected by the MAC layer.

As shown by reference number 510, the UE can select resources in the resource selection window. In some cases, the MAC layer of the UE can randomly select the sidelink resources from the available candidate resources reported by the PHY layer of the UE. To select N candidate resources from the available candidate resources, the UE can first randomly select one of the N candidate resources. For example, the first candidate resource can be selected in slot m₁. Then, the UE can also randomly select second candidate resources, with the restriction that the gap between a second candidate resource and the first selected candidate resource must be smaller than a window W of 32 slots. In this way, the second candidate resources should be located (e.g., in slot m₂) within the range of slots [m₁−31, m₁+31]. If N is larger than 2, the UE can select a third candidate resource but with the restriction that it is located (e.g., in slot m₃) within the range [m₁−31, m₁+31] or [m₂−31, m₂+31]. The above procedure can be repeated until all N candidate resources are selected.

In some cases, SCI can reserve resources for one, two, or three transmissions. A maximum number of reservations can be configured or preconfigured (e.g., specified in a wireless communication standard). In some cases, all reservations can be for the same number of sub-channels. A starting sub-channel can differ between reservations. In some cases, a transmitter UE can request feedback for a given transmission. In some cases, the transmitter UE can elect to not use a reservation based on feedback from other UEs. The reservations in can be repeated with the signaled period when enabled.

If a MAC layer of a UE requests the UE to determine a subset of resources from which the higher layer will select resources for PSSCH/PSCCH transmission as part of a re-evaluation or pre-emption procedure, the higher layer can provide a set of resources (r₀, r₁, r₂, . . . ) which can be subject to re-evaluation and a set of resources

$$( {r}_{0}^{′} , {r}_{1}^{′} , {r}_{2}^{′} , … )$$

which can be subject to preemption. UEs can be configured to determine the subset of resources (as requested by higher layers) before or after the slot

$${r}_{i}^{″} - {T}_{3}$$

(e.g., in slot n′), where

$${r}_{i}^{″}$$

is the slot with the smallest slot index among (r₀, r₁, r₂, . . . ) and

$$( {r}_{0}^{′} , {r}_{1}^{′} , {r}_{2}^{′} , … ) ,$$

and T₃ is equal to

$${T}_{proc , 1}^{SL} ,$$

where

$${T}_{proc , 1}^{SL}$$

is defined in slots according to a wireless communication standard, and where β_{SL} is the subcarrier spacing (SCS) configuration of the sidelink BWP.

In some cases, as shown in example 502 of FIG. 5B, a selected, but not yet reserved, resource could be reserved by another UE. In this case, the resource selection procedure (for re-evaluation) can be triggered. If a subset of selected but not yet reserved resources (e.g., M resources) are indicated for re-evaluation by the physical layer of the UE, the MAC layer of the UE can remove the M resources from the N candidate resources and randomly select M new candidate resources from the available candidate resources within a new selection window.

Sidelink transmissions (which may be referred to herein, interchangeably, as “communications”) may have associated priority levels. In some cases, a UE that has a communication with a higher priority level than, or a same priority level as, a priority level of a communication by another UE may preempt the other UE's resource reservation. For example, a first transmitter UE may reserve a sidelink resource for a communication having a first priority level. A transmitter UE is a UE that transmits a communication, is planning to transmit a communication, is capable of transmitting a communication, and/or the like. A second transmitter UE may reserve the same sidelink resource for a communication having a second priority level. If the second priority level is higher than, or the same as, the first priority level, the second transmitter UE's communication may preempt the first UE's communication, in which case the second transmitter UE may transmit using the reserved resource, while the first transmitter UE does not transmit using that resource. This concept of preemption may facilitate transmission of higher priority transmissions when multiple UEs compete for the same resources.

As shown in example 504, of FIG. 5C, if a resource satisfies a set of conditions, the PHY layer of the UE can report pre-emption of this resource to the MAC layer of the UE. In some cases, the resource satisfies the set of conditions when the resource is reserved by another UE (with priority of prio_{RX}), and the priority prio_{Rx} satisfies one of two priority conditions. The first priority condition (condition 1) can indicate that sl-PreemptionEnable is provided and is equal to ‘enabled’ and prio_{Tx}>prio_{Rx}, since a higher priority value (e.g., prio_{RX}, prio_{Tx}) corresponds to a lower priority level. The second priority condition can indicate that sl-PreemptionEnable is provided and is not equal to ‘enabled’, and prio_{RX}<prioₚᵣₑ and prio_{Tx}>prio_{Rx}, wherein prioₚᵣₑ is a priority threshold configured by sl-PreemptionEnable. If a subset of reserved resources (e.g., M_{R} resources) are indicated for pre-emption by the PHY layer of the UE, the MAC layer of the UE can remove the M_{R} reserved resources and randomly select M_{R} new candidate resources from the available candidate resources within the new selection window.

Selection of sidelink resources, via the MAC layer and the PHY layer for a Mode 2 UE can occur over a resource pool. For example, a set of L_{subCH} contiguous subchannels can be selected for a single-slot resource. In the configured sidelink BWP in the unlicensed channel, each resource pool can be divided into a set of RB sets (LBT channels). Each RB set can be divided into a set of subchannels and each subchannel can be divided into a set of resource blocks (RBs). To use subchannels within an RB set, a related LBT procedure can be successfully performed. The more RB sets that are spanned in the resource selection (e.g., the more RB sets that are at least partially overlapping with the selected L_{subCH} contiguous subchannels), the less likely it is that all required LBTs are to be successful.

To support MCSt in the unlicensed band, multi-slot resources (sets of contiguous single-slot resources) may need to be available. The more RB sets are spanned in the resource selection, the more likely multi-slot candidate resources can be found. The number of candidate multi-slot resources can be increased by increasing the RSRP threshold of resource exclusion, thereby, accepting more collisions with transmissions of reserving UEs. However, increasing the number of RB sets considered in resource selection to increase the likelihood of finding multi-slot resources of a desired length may result in a decreased likelihood of channel access success, thereby negatively impacting sidelink device performance.

Some aspects of the techniques and apparatuses described herein may include using RB set information to facilitate selection of MCSrs from a configured resource pool. The RB set information may include information associated with RB sets and may facilitate selection of MCSrs from RB sets. RB set information may include information associated with LBT failures, overlapping reservations, and/or priorities, among other examples. In some aspects, a MAC layer of the UE may not provide RB set information to the PHY layer, and the PHY layer may identify multi-slot candidate resources within the entire resource pool. In some aspects, the MAC layer may provide pre-selected RB set information as supplementary information to the PHY layer. In some aspects, the PHY layer may provide an ordered listing of MCSr candidates to the MAC layer for resource selection. By considering RB set information when selecting MCSrs (in either an initial resource selection procedure or a re-selection procedure), some aspects may facilitate increasing a likelihood of selecting multi-slot resources of a desired length while mitigating a potential impact on channel access likelihood, thereby positively impacting sidelink device performance.

As indicated above, FIGS. 5A-5C are provided as examples. Other examples may differ from what is described with respect to FIGS. 5A-5C.

FIGS. 6A-6C are diagrams illustrating examples associated with sidelink resource selection based on RB set information for MCSts, in accordance with the present disclosure. As shown in example 600 of FIG. 6A, a UE 602 and a UE 604 may communicate with one another. In some aspects, the UE 602 and the UE 604 may be, be similar to, include, or be included in the UE 405-1 and/or the UE 405-2 depicted in FIG. 4, and/or the UE 120 depicted in FIGS. 1-3.

As shown by reference number 606, the UE 602 may select, based on RB set information 608, at least one MCSr 610. For example, the UE 602 may select the at least one MCSr 610 from a configured resource pool. As shown by reference number 612, the UE 602 may transmit, and the UE 604 may receive, sidelink communications. For example, the UE 602 may transmit a plurality of sidelink communications via the at least one MCSr 610.

In some aspects, as shown in FIG. 6A for example, a MAC layer 614 of the UE 602 does not provide the RB set information 608 to the PHY layer 616. For example, as shown by reference number 618, the MAC layer 614 may provide resource exclusion parameters 620 (e.g., transmission priority, remaining PDB, number of subchannels, reservation period, and/or number of slots) to the PHY layer 616. The resource exclusion parameter 620 may be referred to as resource selection parameters and may be used by the PHY layer 616 to facilitate a resource exclusion procedure 622. As shown, based on the resource exclusion procedure 622, the PHY layer 616 may generate a candidate resource set 624, S_{A}, that includes a plurality of candidate MCSrs associated with the configured resource pool. As shown by reference number 626, the MAC layer 614 may obtain the candidate resource set 624 from the PHY layer 616.

As shown, the MAC layer 614 may perform a selection procedure 628 to select the at least one MCSr 610. For example, the MAC layer 614 may select the at least one MCSr 610 from the configured resource pool. In some aspects, the MAC layer 614 may select the at least one MCSr 610 from the candidate resource set 624. In some aspects, the PHY layer may provide candidate resource information to the MAC layer 614 for facilitating selection of the at least one MCSr. The candidate resource information may indicate, for each candidate MCSr of the candidate resource set 624, a quantity of RB sets spanned by the candidate MCSr. In some aspects, the candidate resource information may be implicitly indicated by the candidate resource set 624.

In some aspects, the candidate resource information may indicate, for each candidate MCSr of the candidate resource set 624, a quantity of a set of overlapping resource reservations that at least partially overlap the candidate MCSr. The overlapping resource reservations may be identified by monitoring SCI-1 reservations. In some aspects, the set of overlapping resource reservations may include one or more overlapping resource reservations, of a plurality of overlapping resource reservations, that satisfy an RSRP condition. For example, the overlapping resource reservations may include only those overlapping reservations having corresponding RSRPs that exceed a threshold. The RSRP condition may be configured (e.g., RRC configured) and/or specified by a wireless communication standard. In some aspects, the candidate resource information may indicate, for each candidate MCSr of the candidate resource set 624, a highest priority associated with one or more overlapping resource reservations. As above, the one or more overlapping resource reservations may include at least one overlapping resource reservation, of a plurality of overlapping resource reservations, that satisfies an RSRP condition.

As shown by reference number 630, the RB set information 608 may be used in the selection procedure 628. In some aspects, the RB set information 608 may be based on an LBT failure report. For example, as shown by reference number 632, the selected MCSr(s) 610 are provided to the PHY layer 616 for use in a channel access procedure 634. The channel access procedure 634 may include an LBT procedure and, as shown by reference number 636, information associated with LBT procedure may be included in the RB set information 608 for subsequent selections of MCSrs. In some aspects, the LBT failure report may indicate a quantity of LBT failures associated with at least one RB set of the configured resource pool. In some aspects, the LBT failure report may indicate that a quantity of LBT failures associated with at least one RB set of the configured resource pool satisfies an LBT failure threshold. For example, if the LBT failure report is provided at the RB set granularity, it may indicate a likelihood of LBT success associated with each RB set. For example, in some aspects, the LBT failure report may indicate a ratio of a number of LBT failures to a number of LBT attempts over a moving window. The window may be RRC configured and/or specified by a wireless communication standard.

In some aspects, the RB set information may be based on at least one set of RSRP measurements corresponding to at least one RB set of the configured resource pool. In some aspects, the RB set information may be based on at least one set of reservation metrics associated with at least one RB set of the configured resource pool. The at least one set of reservation metrics may indicate at least one of an average quantity of reservations associated with the at least one RB set, an average priority of reservations associated with the at least one RB set, or an average ratio of reserved subchannels to quantity of subchannels associated with the at least one RB set. In some aspects, the at least one set of reservation metrics may be associated with a moving window. The moving window may be RRC configured and/or specified by a wireless communication standard.

In some aspects, the RB set information may be provided in any number of different formats. For example, in some aspects, the RB set information may include a list of the RB sets for each resource pool and any additional information associated therewith. In some aspects, each RB set may be indicated by an index (e.g., a relative position of the RB set with respect to a first RB set of the plurality of RB sets configured in the resource pool). In some aspects, the RB set information may be reported (e.g., reported to the MAC layer and/or the PHY layer) according to any number of different reporting schedules and/or configurations. For example, RB set information may be event-driven. For example, RB set information may be reported in association with a channel access and/or a resource selection procedure. In some aspects, RB set information may be reported periodically according to a periodicity that may be configured and/or specified in a wireless communication standard. In some aspects, for example, the periodicity may be based on a time required for computing time averages associated with the RB set information.

FIG. 6B illustrates an example 638 associated with sidelink resource selection based on RB set information for MCSts, in accordance with the present disclosure. The example 638 is similar to the example 600 except that, in example, 638, the PHY layer 616 uses the RB set information. For example, as shown by reference number 640, the PHY layer 616 may use the RB set information to generate the candidate resource set 624. For example, in some aspects, the RB set information may be used to facilitate generating an ordered list of candidates from with the MAC layer 614 may select the MCSr(s) 610. For example, the candidate resource set 624 may include an ordered list of the plurality of candidate MCSrs. The PHY layer 616 may generate the ordered list based on at least one of the RB set information or the candidate resource information. In some aspects, an order associated with the ordered list may be based at least in part on an ordering criterion. The ordering criterion may include at least one of a time-based criterion, an RB set candidate criterion, a listen-before-talk success ratio criterion, an overlapping reservation criterion, or a lowest average priority criterion associated with one or more overlapping reservations. In some aspects, the ordered list may be generated using any number of combinations of ordering criteria.

In some aspects, an order associated with the ordered list may include a first listed group of candidate MCSrs, of the plurality of candidate MCSrs, associated with at least one preferred RB set and a last listed group of candidate MCSrs, of the plurality of candidate MCSrs, associated with at least one non-preferred RB set. For example, the RB set information may indicated RB sets that have some problems, e.g., RB sets for which an LBT consistent failure report from PHY to MAC was triggered. In some aspects, the ordered list may rank one or more overlapping candidate MCSrs using a ranking that indicates that the one or more overlapping candidate MCSrs at least partially overlap at least one non-preferred (e.g., un-selected) RB set. A non-preferred RB set may be an RB set that includes one or more characteristics that may interfere with communications. For example, a non-preferred RB set may be an RB set that is at least partially overlapped by reservations associated with other UEs.

FIG. 6C illustrates an example 642 associated with sidelink resource selection based on RB set information for MCSts, in accordance with the present disclosure. The example 642 is similar to the example 600 except that, in example, 642, the MAC layer 614 uses the RB set information 608, in a pre-selection procedure 644, to generate pre-selected RB set information 646 for use in generating at least one candidate resource set. For example, as shown by reference number 648, the pre-selected RB set information 646 may be provided to the PHY layer 616 along with the resource exclusion parameters 620. The resource exclusion procedure 622 may be performed to generate at least one candidate resource set 624.

In some aspects, the at least one candidate resource set may be based on the pre-selected RB set information. The pre-selected RB set information may indicate at least one un-selected RB set, which may be interchangeably referred to as a “non-preferred RB set.” For example, in some aspects, the PHY layer 616 may generate the at least one candidate resource set based on selecting the plurality of MCSrs from a subset of the configured resource pool, where the subset omits the at least one un-selected RB set. In some aspects, the PHY layer 616 may generate the at least one candidate resource set based on selecting the plurality of MCSrs from the configured resource pool, and may indicate, in the RB set information, at least one overlapping MCSr that at least partially overlaps the at least one un-selected RB set.

In some aspects, the pre-selected RB set information may include a set of RB set indexes, each RB set index of the set of RB set indexes corresponding to an RB set of the configured resource pool. In some aspects, the pre-selected RB set information may indicate at least one pre-selected RB set, which may be interchangeably referred to as a “preferred RB set.” In some aspects, a quantity of pre-selected RB sets, of the at least one pre-selected RB set, may be based on a quantity of subchannels associated with the at least one MCSr. In some aspects, the UE may receive an RRC message configuration that indicates a quantity of pre-selected RB sets, of the at least one pre-selected RB set. In some aspects, the UE may obtain, from a memory of the UE, an indication of a quantity of pre-selected RB sets, of the at least one pre-selected RB set. In some aspects, a quantity of pre-selected RB sets, of the at least one pre-selected RB set, may be based on a dynamic determination based on at least one pre-selection parameter. For example, the at least one pre-selection parameter may indicate at least one of a quantity of consecutive slots associated with the at least one MCSr, a channel busy ratio measurement, or the RB set information. In some aspects, similarly to the selection of an amount of frequency resources, the number of RB sets can be determined to be between two RRC parameters indicating a minimum and a maximum number, where the specific number is determined based on a list having entries based on one or more of a number of subchannels, N, a transmission priority, prio_{TX}, and a channel busy rate (CBR) measurement.

In some aspects, the at least one candidate resource set 624 may be generated based on selecting the plurality of MCSrs from the at least one pre-selected RB set. For example, in some aspects, generating the at least one candidate resource set 624 may include selecting a preliminary candidate resource set based on a resource exclusion operation and selecting the plurality of MCSrs from an intersection set comprising an intersection of the preliminary candidate resource set and the at least one pre-selected RB set. In some aspects, selecting the preliminary candidate resource set may include selecting the preliminary candidate resource set based on a quantity of MCSrs in a prior intersection set failing to satisfy an intersection threshold. In some aspects, the PHY layer 616 may receive the pre-selected RB set information based on a quantity of MCSrs in a prior intersection set failing to satisfy an intersection threshold.

In some aspects, the at least one pre-selected RB set may include a plurality of pre-selected RB sets and the at least one candidate resource set may include a plurality of candidate resource sets. Each candidate resource set of the plurality of candidate resource sets may correspond to a respective pre-selected RB set of the plurality of pre-selected RB sets. In some aspects, the MAC layer 614 may obtain, from the PHY layer 616, a plurality of candidate resource information sets and each of the plurality of candidate resource information sets may correspond to a respective candidate resource set of the plurality of candidate resource sets. Each candidate resource information set of the plurality of candidate resource information sets may indicate, for a corresponding candidate resource set, a quantity of RSRP threshold increases associated with the candidate resource set satisfying a target ratio. The MAC layer 614 may select the at least one MCSr based on at least one of the plurality of candidate resource information sets satisfying a selection condition. For example, the at least one of the plurality of candidate resource information sets may satisfy the selection condition based on at least one quantity of RSRP threshold increases, associated with the candidate resource set satisfying a target ratio, satisfying a quantity threshold. The at least one of the plurality of candidate resource information sets may satisfy the selection condition based on a quantity of overlapping resource reservations satisfying a quantity condition. The selection condition may be RRC configured and/or specified in a wireless communication standard.

For example, MAC layer 614 may provide S different sets of K RB sets to PHY layer 616. The PHY layer 616 may provide a set of candidates S_{A} for each of the S sets of K RB sets. The PHY layer 616 may provide candidate resource information (to indicate the level of “busy-ness” of each set of RB sets) to facilitate the selection of a candidate resource across the multiple S_{A} in the MAC layer. The candidate resource information may include, for example, for each S_{A}, a quantity of RSRP threshold increases incurred to meet the target ratio Y of candidate resources. For example, the PHY layer 616 may provides the S_{A} only when a target ratio Y of available resources after the RSRP-based resource exclusion is met, and, if the target ratio is not met, the PHY layer 616 may increase the RSRP threshold and performs resource exclusion again. In some aspects, the candidate resource information may indicate, for each candidate resource, a quantity of (at least partially) overlapping allocations from other UEs. The candidate resource information may be checked to determine whether to loop-back to RB sets pre-selection procedure 644 or to proceed to the selection procedure 628. The condition may be based on the candidate resource information.

If the RB set pre-selection procedure 644 is performed again, the MAC layer 614 may increase the number of RB sets in each set to K′ and determine a new set S′ accordingly. The condition used to determine whether to perform the pre-selection procedure 644 again may include comparing candidate resource information to a threshold. For example, a function of the quantity of at least partially overlapping reservations may be compared to a threshold. The function may include, for example, a mean, median, minimum, and/or maximum, of the quantity of overlapping reservations, computed across the provided candidate resources within each candidate resource set 624.

As indicated above, FIGS. 6A-6C are provided as examples. Other examples may differ from what is described with respect to FIGS. 6A-6C.

FIG. 7 is a diagram illustrating an example process 700 performed, for example, by a UE, in accordance with the present disclosure. Example process 700 is an example where the UE (e.g., UE 602) performs operations associated with sidelink resource selection based on RB set information for MCSrs.

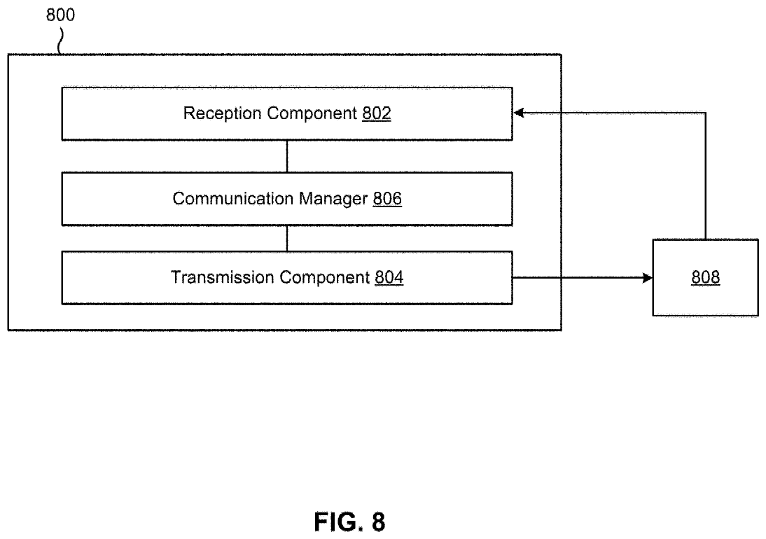

As shown in FIG. 7, in some aspects, process 700 may include selecting, based at least in part on RB set information, at least one MCSr from a configured resource pool (block 710). For example, the UE (e.g., using communication manager 806, depicted in FIG. 8) may select, based at least in part on RB set information, at least one MCSr from a configured resource pool, as described above.

As further shown in FIG. 7, in some aspects, process 700 may include transmitting, based at least in part on a channel access procedure, a plurality of sidelink communications via the at least one MCSr (block 720). For example, the UE (e.g., using transmission component 804 and/or communication manager 806, depicted in FIG. 8) may transmit, based at least in part on a channel access procedure, a plurality of sidelink communications via the at least one MCSr, as described above.

Process 700 may include additional aspects, such as any single aspect or any combination of aspects described below and/or in connection with one or more other processes described elsewhere herein.

In a first aspect, selecting the at least one MCSr comprises obtaining, by a MAC layer of the UE from a PHY layer of the UE, a candidate resource set comprising a plurality of candidate MCSrs associated with the configured resource pool, wherein selecting the at least one MCSr comprises selecting the at least one MCSr from the configured resource pool. In a second aspect, alone or in combination with the first aspect, process 700 includes obtaining, by the MAC layer from the PHY layer, candidate resource information for facilitating selection of the at least one MCSr, wherein selecting the at least one MCSr comprises selecting the at least one MCSr further based on the candidate resource information. In a third aspect, alone or in combination with the second aspect, the candidate resource information indicates, for each candidate MCSr of the candidate resource set, a quantity of RB sets spanned by the candidate MCSr. In a fourth aspect, alone or in combination with the third aspect, the candidate resource information is implicitly indicated by the candidate resource set.

In a fifth aspect, alone or in combination with one or more of the second through fourth aspects, the candidate resource information indicates, for each candidate MCSr of the candidate resource set, a quantity of a set of overlapping resource reservations that at least partially overlap the candidate MCSr. In a sixth aspect, alone or in combination with the fifth aspect, the set of overlapping resource reservations comprises one or more overlapping resource reservations, of a plurality of overlapping resource reservations, that satisfy a reference signal received power condition. In a seventh aspect, alone or in combination with one or more of the second through sixth aspects, the candidate resource information indicates, for each candidate MCSr of the candidate resource set, a highest priority associated with one or more overlapping resource reservations. In an eighth aspect, alone or in combination with the seventh aspect, the one or more overlapping resource reservations comprise at least one overlapping resource reservation, of a plurality of overlapping resource reservations, that satisfies a reference signal received power condition. In a ninth aspect, alone or in combination with the eighth aspect, the candidate resource set comprises an ordered list of the plurality of candidate MCSrs, process 700 including generating, by the PHY layer, the ordered list based on at least one of the RB set information or the candidate resource information. In a tenth aspect, alone or in combination with one or more of the second through ninth aspects, an order associated with the ordered list is based at least in part on an ordering criterion, the ordering criterion comprising at least one of a time-based criterion, an RB set candidate criterion, a listen-before-talk success ratio criterion, an overlapping reservation criterion, or a lowest average priority criterion associated with one or more overlapping reservations. In some aspects, an order associated with the ordered list includes a first listed group of candidate MCSrs, of the plurality of candidate MCSrs, associated with at least one preferred RB set and a last listed group of candidate MCSrs, of the plurality of candidate MCSrs, associated with at least one non-preferred RB set.

In an eleventh aspect, selecting the at least one MCSr comprises providing, to a PHY layer of the UE from a MAC layer of the UE, pre-selected RB set information associated with the configured resource pool, and receiving at least one candidate resource set comprising a plurality of MCSrs, wherein the at least one candidate resource set is based on the pre-selected RB set information, and selecting the at least one MCSr comprises selecting the at least one MCSr from the at least one candidate resource set. In a twelfth aspect, alone or in combination with the eleventh aspect, the pre-selected RB set information indicates at least one un-selected RB set. In a thirteenth aspect, alone or in combination with the twelfth aspect, process 700 includes generating the at least one candidate resource set based on selecting the plurality of MCSrs from a subset of the configured resource pool, wherein the subset omits the at least one un-selected RB set. In a fourteenth aspect, alone or in combination with one or more of the twelfth or thirteenth aspects, process 700 includes generating the at least one candidate resource set based on selecting the plurality of MCSrs from the configured resource pool, wherein the at least one candidate resource set includes a ranking associated with at least one overlapping MCSr, wherein the ranking indicates that the at least one overlapping MCSr at least partially overlaps the at least one un-selected RB set.

In a fifteenth aspect, alone or in combination with one or more of the eleventh through fourteenth aspects, the pre-selected RB set information comprises a set of RB set indexes, each RB set index of the set of RB set indexes corresponding to an RB set of the configured resource pool. In a sixteenth aspect, alone or in combination with one or more of the eleventh through fifteenth aspects, the pre-selected RB set information indicates at least one pre-selected RB set. In a seventeenth aspect, alone or in combination with the sixteenth aspect, a quantity of pre-selected RB sets, of the at least one pre-selected RB set, is based on a quantity of subchannels associated with the at least one MCSr. In an eighteenth aspect, alone or in combination with one or more of the sixteenth or seventeenth aspects, process 700 includes receiving a radio resource control message configuration that indicates a quantity of pre-selected RB sets, of the at least one pre-selected RB set. In a nineteenth aspect, alone or in combination with one or more of the sixteenth through eighteenth aspects, process 700 includes obtaining, from a memory of the UE, an indication of a quantity of pre-selected RB sets, of the at least one pre-selected RB set.

In a twentieth aspect, alone or in combination with one or more of the sixteenth through nineteenth aspects, a quantity of pre-selected RB sets, of the at least one pre-selected RB set, is based on a dynamic determination based on at least one pre-selection parameter. In a twenty-first aspect, alone or in combination with the twentieth aspect, the at least one pre-selection parameter indicates at least one of a quantity of consecutive slots associated with the at least one MCSr, a channel busy ratio measurement, or the RB set information. In a twenty-second aspect, alone or in combination with one or more of the sixteenth through twenty-first aspects, process 700 includes generating the at least one candidate resource set based on selecting the plurality of MCSrs from the at least one pre-selected RB set.

In a twenty-third aspect, alone or in combination with one or more of the sixteenth through twenty-second aspects, process 700 includes generating the at least one candidate resource set, comprising selecting a preliminary candidate resource set based on a resource exclusion operation, and selecting the plurality of MCSrs from an intersection set comprising an intersection of the preliminary candidate resource set and the at least one pre-selected RB set. In a twenty-fourth aspect, alone or in combination with the twenty-third aspect, selecting the preliminary candidate resource set comprises selecting the preliminary candidate resource set based on a quantity of MCSrs in a prior intersection set failing to satisfy an intersection threshold. In a twenty-fifth aspect, alone or in combination with one or more of the twenty-third or twenty-fourth aspects, receiving the pre-selected RB set information comprises receiving the pre-selected RB set information based on a quantity of MCSrs in a prior intersection set failing to satisfy an intersection threshold.

In a twenty-sixth aspect, alone or in combination with one or more of the sixteenth through twenty-fifth aspects, the at least one pre-selected RB set comprises a plurality of pre-selected RB sets and the at least one candidate resource set comprises a plurality of candidate resource sets, each candidate resource set of the plurality of candidate resource sets corresponding to a respective pre-selected RB set of the plurality of pre-selected RB sets. In a twenty-seventh aspect, alone or in combination with the twenty-sixth aspect, process 700 includes obtaining, by the MAC layer from the PHY layer, a plurality of candidate resource information sets, each of the plurality of candidate resource information sets corresponding to a respective candidate resource set of the plurality of candidate resource sets. In a twenty-eighth aspect, alone or in combination with the twenty-seventh aspects, each candidate resource information set of the plurality of candidate resource information sets indicates, for a corresponding candidate resource set, a quantity of reference signal received power threshold increases associated with the candidate resource set satisfying a target ratio. In a twenty-ninth aspect, alone or in combination with one or more of the twenty-seventh or twenty-eighth aspects, selecting the at least one MCSr comprises selecting the at least one MCSr from the plurality of candidate resource sets based on at least one of the plurality of candidate resource information sets satisfying a selection condition. In a thirtieth aspect, alone or in combination with the twenty-ninth aspect, the at least one of the plurality of candidate resource information sets satisfies the selection condition based on at least one quantity of reference signal received power threshold increases, associated with the candidate resource set satisfying a target ratio, satisfying a quantity threshold. In a thirty-first aspect, alone or in combination with one or more of the twenty-ninth or thirtieth aspects, the at least one of the plurality of candidate resource information sets satisfies the selection condition based on a quantity of overlapping resource reservations satisfying a quantity condition.

In a thirty-second aspect, alone or in combination with one or more of the twenty-ninth through thirty-first aspects, process 700 includes receiving a radio resource control configuration message indicating the selection condition. In a thirty-third aspect, alone or in combination with one or more of the twenty-ninth through thirty-second aspects, process 700 includes obtaining, from a memory of the UE, an indication of the selection condition. In a thirty-fourth aspect, the RB set information is based on an LBT failure report. In a thirty-fifth aspect, alone or in combination the thirty-fourth aspect, the LBT failure report indicates a quantity of LBT failures associated with at least one RB set of the configured resource pool. In a thirty-sixth aspect, alone or in combination with one or more of the thirty-fourth or thirty-fifth aspects, the LBT failure report indicates that a quantity of LBT failures associated with at least one RB set of the configured resource pool satisfies an LBT failure threshold.

In a thirty-seventh aspect, alone or in combination with one or more of the first through thirty-sixth aspects, the RB set information is based on at least one set of RSRP measurements corresponding to at least one RB set of the configured resource pool. In a thirty-eighth aspect, alone or in combination with one or more of the first through thirty-seventh aspects, the RB set information is based on at least one set of reservation metrics associated with at least one RB set of the configured resource pool. In a thirty-ninth aspect, alone or in combination with the thirty-eighth aspect, the at least one set of reservation metrics indicates at least one of an average quantity of reservations associated with the at least one RB set, an average priority of reservations associated with the at least one RB set, or an average ratio of reserved subchannels to quantity of subchannels associated with the at least one RB set. In a fortieth aspect, alone or in combination with one or more of the thirty-eighth or thirty-ninth aspects, the at least one set of reservation metrics is associated with a moving window. In a forty-first aspect, alone or in combination with the fortieth aspect, process 700 includes receiving a radio resource control configuration message indicating the moving window. In a forty-second aspect, alone or in combination with one or more of the fortieth through forty-first aspects, process 700 includes obtaining an indication of the moving window from a memory of the UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 6A-6C. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

In some examples, means for transmitting, outputting, or sending (or means for outputting for transmission) may include one or more antennas, a modulator, a transmit MIMO processor, a transmit processor, or a combination thereof, of the UE described above in connection with FIG. 2.

In some examples, means for receiving (or means for obtaining) may include one or more antennas, a demodulator, a MIMO detector, a receive processor, or a combination thereof, of the UE described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for providing, obtaining, receiving, transmitting, selecting, and/or generating may include various processing system components, such as a receive processor, a transmit processor, a controller/processor, a memory, or a combination thereof, of the UE described above in connection with FIG. 2.

The communication manager 806 may select, based at least in part on RB set information, at least one MCSr from a configured resource pool. The transmission component 804 may transmit, based at least in part on a channel access procedure, a plurality of sidelink communications via the at least one MCSr. The reception component 802 may obtain candidate resource information for facilitating selection of the at least one MCSr, wherein selecting the at least one MCSr comprises selecting the at least one MCSr further based on the candidate resource information. The communication manager 806 may generate the at least one candidate resource set based on selecting the plurality of MCSrs from a subset of the configured resource pool, wherein the subset omits the at least one un-selected RB set. The communication manager 806 may generate the at least one candidate resource set based on selecting the plurality of MCSrs from the configured resource pool, wherein the RB set information indicates at least one overlapping MCSr that at least partially overlaps the at least one un-selected RB set.

The reception component 802 may receive a radio resource control message configuration that indicates a quantity of pre-selected RB sets, of the at least one pre-selected RB set. The reception component 802 may obtain, from a memory of the UE, an indication of a quantity of pre-selected RB sets, of the at least one pre-selected RB set. The communication manager 806 may generate the at least one candidate resource set based on selecting the plurality of MCSrs from the at least one pre-selected RB set. The communication manager 806 may generate the at least one candidate resource set, comprising selecting a preliminary candidate resource set based on a resource exclusion operation; and selecting the plurality of MCSrs from an intersection set comprising an intersection of the preliminary candidate resource set and the at least one pre-selected RB set. The reception component 802 may obtain a plurality of candidate resource information sets, each of the plurality of candidate resource information sets corresponding to a respective candidate resource set of the plurality of candidate resource sets. The reception component 802 may receive a radio resource control configuration message indicating the selection condition. The reception component 802 may obtain, from a memory of the UE, an indication of the selection condition. The reception component 802 may receive a radio resource control configuration message indicating the moving window. The reception component 802 may obtain an indication of the moving window from a memory of the UE.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

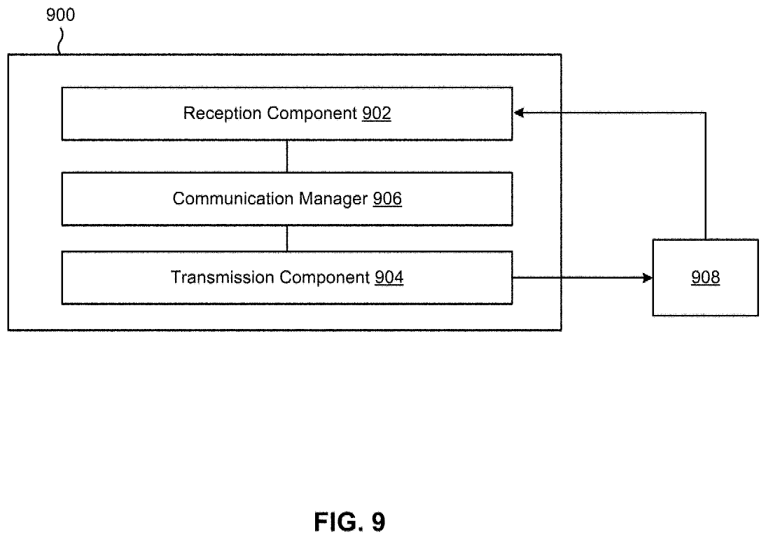

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 6A-6C. Additionally, or alternatively, the apparatus 900 may be configured to perform one or more processes described herein. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

In some examples, means for transmitting, outputting, or sending (or means for outputting for transmission) may include one or more antennas, a modulator, a transmit MIMO processor, a transmit processor, or a combination thereof, of the UE described above in connection with FIG. 2. For example, the means for transmitting may be configured to transmit a sidelink configuration to a UE to support sidelink operations described herein.

In some examples, means for receiving (or means for obtaining) may include one or more antennas, a demodulator, a MIMO detector, a receive processor, or a combination thereof, of the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for providing, obtaining, receiving, transmitting, selecting, and/or generating may include various processing system components, such as a receive processor, a transmit processor, a controller/processor, a memory, or a combination thereof, of the network node described above in connection with FIG. 2.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE) over an unlicensed spectrum carrier, comprising: selecting, based at least in part on resource block (RB) set information, at least one multi consecutive slot resource (MCSr) from a configured resource pool; and transmitting, based at least in part on a channel access procedure, a plurality of sidelink communications via the at least one MCSr.

Aspect 2: The method of Aspect 1, wherein selecting the at least one MCSr comprises obtaining, by a medium access control (MAC) layer of the UE from a physical (PHY) layer of the UE, a candidate resource set comprising a plurality of candidate MCSrs associated with the configured resource pool, wherein selecting the at least one MCSr comprises selecting the at least one MCSr from the configured resource pool.

Aspect 3: The method of Aspect 2, further comprising obtaining, by the MAC layer from the PHY layer, candidate resource information for facilitating selection of the at least one MCSr, wherein selecting the at least one MCSr comprises selecting the at least one MCSr further based on the candidate resource information.

Aspect 4: The method of Aspect 3, wherein the candidate resource information indicates, for each candidate MCSr of the candidate resource set, a quantity of RB sets spanned by the candidate MCSr.

Aspect 5: The method of Aspect 4, wherein the candidate resource information is implicitly indicated by the candidate resource set.

Aspect 6: The method of any of Aspects 3-5, wherein the candidate resource information indicates, for each candidate MCSr of the candidate resource set, a quantity of a set of overlapping resource reservations that at least partially overlap the candidate MCSr.

Aspect 7: The method of Aspect 6, wherein the set of overlapping resource reservations comprises one or more overlapping resource reservations, of a plurality of overlapping resource reservations, that satisfy a reference signal received power condition.

Aspect 8: The method of any of Aspects 3-7, wherein the candidate resource information indicates, for each candidate MCSr of the candidate resource set, a highest priority associated with one or more overlapping resource reservations.

Aspect 9: The method of Aspect 8, wherein the one or more overlapping resource reservations comprise at least one overlapping resource reservation, of a plurality of overlapping resource reservations, that satisfies a reference signal received power condition.

Aspect 10: The method of any of Aspects 3-9, wherein the candidate resource set comprises an ordered list of the plurality of candidate MCSrs, the method further comprising generating, by the PHY layer, the ordered list based on at least one of the RB set information or the candidate resource information.

Aspect 11: The method of Aspect 10, wherein an order associated with the ordered list is based at least in part on an ordering criterion, the ordering criterion comprising at least one of a time-based criterion, an RB set candidate criterion, a listen-before-talk success ratio criterion, an overlapping reservation criterion, or a lowest average priority criterion associated with one or more overlapping reservations.

Aspect 12: The method of Aspect 1, wherein selecting the at least one MCSr comprises: providing, to a physical (PHY) layer of the UE from a medium access control (MAC) layer of the UE, pre-selected RB set information associated with the configured resource pool; and receiving, by the MAC layer of the UE from the PHY layer of the UE, at least one candidate resource set comprising a plurality of MCSrs, wherein the at least one candidate resource set is based on the pre-selected RB set information, and wherein selecting the at least one MCSr comprises selecting the at least one MCSr from the at least one candidate resource set.

Aspect 13: The method of Aspect 12, wherein the pre-selected RB set information indicates at least one un-selected RB set.

Aspect 14: The method of Aspect 13, further comprising generating the at least one candidate resource set based on selecting the plurality of MCSrs from a subset of the configured resource pool, wherein the subset omits the at least one un-selected RB set.

Aspect 15: The method of either of Aspects 13 or 14, further comprising generating the at least one candidate resource set based on selecting the plurality of MCSrs from the configured resource pool, wherein the at least one candidate resource set includes a ranking associated with at least one overlapping MCSr, wherein the ranking indicates that the at least one overlapping MCSr at least partially overlaps the at least one un-selected RB set.

Aspect 16: The method of any of Aspects 12-15, wherein the pre-selected RB set information comprises a set of RB set indexes, each RB set index of the set of RB set indexes corresponding to an RB set of the configured resource pool.

Aspect 17: The method of any of Aspects 12-16, wherein the pre-selected RB set information indicates at least one pre-selected RB set.

Aspect 18: The method of Aspect 17, wherein a quantity of pre-selected RB sets, of the at least one pre-selected RB set, is based on a quantity of subchannels associated with the at least one MCSr.

Aspect 19: The method of either of Aspects 17 or 18, further comprising receiving a radio resource control message configuration that indicates a quantity of pre-selected RB sets, of the at least one pre-selected RB set.

Aspect 20: The method of any of Aspects 17-19, further comprising obtaining, from a memory of the UE, an indication of a quantity of pre-selected RB sets, of the at least one pre-selected RB set.

Aspect 21: The method of any of Aspects 17-20, wherein a quantity of pre-selected RB sets, of the at least one pre-selected RB set, is based on a dynamic determination based on at least one pre-selection parameter.

Aspect 22: The method of Aspect 21, wherein the at least one pre-selection parameter indicates at least one of a quantity of consecutive slots associated with the at least one MCSr, a channel busy ratio measurement, or the RB set information.

Aspect 23: The method of any of Aspects 17-22, further comprising generating the at least one candidate resource set based on selecting the plurality of MCSrs from the at least one pre-selected RB set.

Aspect 24: The method of any of Aspects 17-23, further comprising generating the at least one candidate resource set, comprising: selecting a preliminary candidate resource set based on a resource exclusion operation; and selecting the plurality of MCSrs from an intersection set comprising an intersection of the preliminary candidate resource set and the at least one pre-selected RB set.

Aspect 25: The method of Aspect 24, wherein selecting the preliminary candidate resource set comprises selecting the preliminary candidate resource set based on a quantity of MCSrs in a prior intersection set failing to satisfy an intersection threshold.

Aspect 26: The method of either of Aspects 24 or 25, wherein receiving the pre-selected RB set information comprises receiving the pre-selected RB set information based on a quantity of MCSrs in a prior intersection set failing to satisfy an intersection threshold.

Aspect 27: The method of any of Aspects 17-26, wherein the at least one pre-selected RB set comprises a plurality of pre-selected RB sets and wherein the at least one candidate resource set comprises a plurality of candidate resource sets, each candidate resource set of the plurality of candidate resource sets corresponding to a respective pre-selected RB set of the plurality of pre-selected RB sets.

Aspect 28: The method of Aspect 27, further comprising obtaining, by the MAC layer from the PHY layer, a plurality of candidate resource information sets, each of the plurality of candidate resource information sets corresponding to a respective candidate resource set of the plurality of candidate resource sets.

Aspect 29: The method of Aspect 28, wherein each candidate resource information set of the plurality of candidate resource information sets indicates, for a corresponding candidate resource set, a quantity of reference signal received power threshold increases associated with the candidate resource set satisfying a target ratio.

Aspect 30: The method of either of Aspects 28 or 29, wherein selecting the at least one MCSr comprises selecting the at least one MCSr from the plurality of candidate resource sets based on at least one of the plurality of candidate resource information sets satisfying a selection condition.

Aspect 31: The method of Aspect 30, wherein the at least one of the plurality of candidate resource information sets satisfies the selection condition based on at least one quantity of reference signal received power threshold increases, associated with the candidate resource set satisfying a target ratio, satisfying a quantity threshold.

Aspect 32: The method of either of Aspects 30 or 31, wherein the at least one of the plurality of candidate resource information sets satisfies the selection condition based on a quantity of overlapping resource reservations satisfying a quantity condition.

Aspect 33: The method of any of Aspects 30-32, further comprising receiving a radio resource control configuration message indicating the selection condition.

Aspect 34: The method of any of Aspects 30-33, further comprising obtaining, from a memory of the UE, an indication of the selection condition.

Aspect 35: The method of Aspect 1, wherein the RB set information is based on a listen-before-talk (LBT) failure report.

Aspect 36: The method of Aspect 35, wherein the LBT failure report indicates a quantity of LBT failures associated with at least one RB set of the configured resource pool.

Aspect 37: The method of either of Aspects 35 or 36, wherein the LBT failure report indicates that a quantity of LBT failures associated with at least one RB set of the configured resource pool satisfies an LBT failure threshold.

Aspect 38: The method of any of Aspects 1-37, wherein the RB set information is based on at least one set of reference signal received power (RSRP) measurements corresponding to at least one RB set of the configured resource pool.

Aspect 39: The method of any of Aspects 1-38, wherein the RB set information is based on at least one set of reservation metrics associated with at least one RB set of the configured resource pool.

Aspect 40: The method of Aspect 39, wherein the at least one set of reservation metrics indicates at least one of an average quantity of reservations associated with the at least one RB set, an average priority of reservations associated with the at least one RB set, or an average ratio of reserved subchannels to quantity of subchannels associated with the at least one RB set.

Aspect 41: The method of either of Aspects 39 or 40, wherein the at least one set of reservation metrics is associated with a moving window.

Aspect 42: The method of Aspect 41, further comprising receiving a radio resource control configuration message indicating the moving window.

Aspect 43: The method of either of Aspects 41 or 42, further comprising obtaining an indication of the moving window from a memory of the UE.

Aspect 44: The method of Aspect 10, wherein an order associated with the ordered list includes a first listed group of candidate MCSrs, of the plurality of candidate MCSrs, associated with at least one preferred RB set and a last listed group of candidate MCSrs, of the plurality of candidate MCSrs, associated with at least one non-preferred RB set.

Aspect 45: An apparatus for wireless communication at a device, comprising a processor; memory coupled with the processor; and instructions stored in the memory and executable by the processor to cause the apparatus to perform the method of one or more of Aspects 1-44.

Aspect 46: A device for wireless communication, comprising a memory and one or more processors coupled to the memory, the one or more processors configured to perform the method of one or more of Aspects 1-44.

Aspect 47: An apparatus for wireless communication, comprising at least one means for performing the method of one or more of Aspects 1-44.

Aspect 48: A non-transitory computer-readable medium storing code for wireless communication, the code comprising instructions executable by a processor to perform the method of one or more of Aspects 1-44.

Aspect 49: A non-transitory computer-readable medium storing a set of instructions for wireless communication, the set of instructions comprising one or more instructions that, when executed by one or more processors of a device, cause the device to perform the method of one or more of Aspects 1-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication over an unlicensed spectrum carrier, comprising:
a memory; and
one or more processors coupled to the memory and configured to cause the UE to:
select, based at least in part on resource block (RB) set information, at least one multi consecutive slot resource (MCSr) from a configured resource pool; and
transmit, based at least in part on a channel access procedure, a plurality of sidelink communications via the at least one MCSr.

2. The UE of claim 1, wherein selecting the at least one MCSr comprises obtaining, by a medium access control (MAC) layer of the UE from a physical (PHY) layer of the UE, a candidate resource set comprising a plurality of candidate MCSrs associated with the configured resource pool, wherein selecting the at least one MCSr comprises selecting the at least one MCSr from the configured resource pool.

3. The UE of claim 2, wherein the one or more processors are further configured to obtain candidate resource information for facilitating selection of the at least one MCSr, wherein selecting the at least one MCSr comprises selecting the at least one MCSr further based on the candidate resource information.

4. The UE of claim 3, wherein the candidate resource information indicates, for each candidate MCSr of the candidate resource set, either a quantity of RB sets spanned by the candidate MCSr or a quantity of a set of overlapping resource reservations that at least partially overlap the candidate MCSr.

5. (canceled)

6. The UE of claim 3, wherein the candidate resource information indicates, for each candidate MCSr of the candidate resource set, a highest priority associated with one or more overlapping resource reservations, wherein the one or more overlapping resource reservations comprise at least one overlapping resource reservation, of a plurality of overlapping resource reservations, that satisfies a reference signal received power condition.

7. The UE of claim 3, wherein the candidate resource set comprises an ordered list of the plurality of candidate MCSrs, and wherein the one or more processors are further configured to cause the UE to generate, by the PHY layer, the ordered list based on at least one of the RB set information or the candidate resource information, wherein an order associated with the ordered list is based at least in part on an ordering criterion, the ordering criterion comprising at least one of a time-based criterion, an RB set candidate criterion, a listen-before-talk success ratio criterion, an overlapping reservation criterion, or a lowest average priority criterion associated with one or more overlapping reservations.

8. The UE of claim 1, wherein the one or more processors, to select the at least one MCSr, are configured to:
provide, to a physical (PHY) layer of the UE from a medium access control (MAC) layer of the UE, pre-selected RB set information associated with the configured resource pool; and
receive at least one candidate resource set comprising a plurality of MCSrs, wherein the at least one candidate resource set is based on the pre-selected RB set information, and wherein selecting the at least one MCSr comprises selecting the at least one MCSr from the at least one candidate resource set.

9. The UE of claim 8, wherein the pre-selected RB set information indicates at least one un-selected RB set.

10. (canceled)

11. The UE of claim 9, wherein the one or more processors are further configured to generate the at least one candidate resource set based on selecting the plurality of MCSrs from the configured resource pool, wherein the at least one candidate resource set includes a ranking associated with at least one overlapping MCSr, wherein the ranking indicates that the at least one overlapping MCSr at least partially overlaps the at least one un-selected RB set.

12. (canceled)

13. The UE of claim 8, wherein the pre-selected RB set information indicates at least one pre-selected RB set.

14. The UE of claim 13, wherein a quantity of pre-selected RB sets, of the at least one pre-selected RB set, is based on a quantity of subchannels associated with the at least one MCSr.

15. The UE of claim 13, wherein the one or more processors are further configured to receive a radio resource control message configuration that indicates a quantity of pre-selected RB sets, of the at least one pre-selected RB set.

16. The UE of claim 13, wherein the one or more processors are further configured to obtain, from a memory of the UE, an indication of a quantity of pre-selected RB sets, of the at least one pre-selected RB set.

17. The UE of claim 13, wherein a quantity of pre-selected RB sets, of the at least one pre-selected RB set, is based on a dynamic determination based on at least one pre-selection parameter, wherein the at least one pre-selection parameter indicates at least one of a quantity of consecutive slots associated with the at least one MCSr, a channel busy ratio measurement, or the RB set information.

18. (canceled)

19. The UE of claim 17, wherein the one or more processors are further configured to generate the at least one candidate resource set, comprising:
select a preliminary candidate resource set based on a resource exclusion operation; and
select the plurality of MCSrs from an intersection set comprising an intersection of the preliminary candidate resource set and the at least one pre-selected RB set.

20. The UE of claim 17, wherein the at least one pre-selected RB set comprises a plurality of pre-selected RB sets and wherein the at least one candidate resource set comprises a plurality of candidate resource sets, each candidate resource set of the plurality of candidate resource sets corresponding to a respective pre-selected RB set of the plurality of pre-selected RB sets, and wherein the one or more processors are further configured to cause the UE to obtain, by the MAC layer from the PHY layer, a plurality of candidate resource information sets, each of the plurality of candidate resource information sets corresponding to a respective candidate resource set of the plurality of candidate resource sets.

21. (canceled)

22. The UE of claim 1, wherein the RB set information is based on a listen-before-talk (LBT) failure report or at least one set of reference signal received power (RSRP) measurements corresponding to at least one RB set of the configured resource pool.

23. (canceled)

24. The UE of claim 1, wherein the RB set information is based on at least one set of reservation metrics associated with at least one RB set of the configured resource pool, wherein the at least one set of reservation metrics indicates at least one of an average quantity of reservations associated with the at least one RB set, an average priority of reservations associated with the at least one RB set, or an average ratio of reserved subchannels to quantity of subchannels associated with the at least one RB set, and wherein the at least one set of reservation metrics is associated with a moving window.

25. A method of wireless communication performed by a user equipment (UE) over an unlicensed spectrum carrier, comprising:
selecting, based at least in part on resource block (RB) set information, at least one multi consecutive slot resource (MCSr) from a configured resource pool; and
transmitting, based at least in part on a channel access procedure, a plurality of sidelink communications via the at least one MCSr.

26-28. (canceled)

29. An apparatus for wireless communication, comprising:
means for selecting, based at least in part on resource block (RB) set information, at least one multi consecutive slot resource (MCSr) from a configured resource pool; and
means for transmitting, based at least in part on a channel access procedure, a plurality of sidelink communications via the at least one MCSr.

30. (canceled)
